(19) United States
(12) Patent Application Publication
(10) Pub. No.: US 2026/0193431 A1
(43) Pub. Date: Jul. 9, 2026

(54) METHOD FOR PRODUCING THERMALLY CONDUCTIVE SHEET

(71) Applicant: KANEKA CORPORATION, Osaka (JP)

(72) Inventor: Yasushi NISHIKAWA, Settsu-shi (JP)

(73) Assignee: KANEKA CORPORATION, Osaka (JP)

(21) Appl. No.: 19/299,143

(22) Filed: Aug. 13, 2025

(30) Foreign Application Priority Data
Aug. 15, 2024 (JP) 2024-135617

(51) Int. Cl. C08J 5/18; B32B 27/08; B32B 27/36; B32B 38/00; C08K 3/04

(52) U.S. Cl. CPC C08J 5/18; B32B 27/08; B32B 27/36; B32B 38/0004; C08K 3/042; B32B 2307/302; B32B 2307/72; B32B 2307/7376; B32B 2367/00; C08J 2333/08

(57) ABSTRACT

A method for producing a thermally conductive sheet having excellent thermal conductivity, an excellent temporary attachment property, and excellent adhesion, includes: a primary sheet forming step of obtaining a primary sheet by forming, in sheet form, a mixture containing graphite particles (A), an organic polymer compound (B), and a solvent; a laminate forming step of obtaining a laminate, by stacking a plurality of the primary sheets while applying pressure so that thickness of the primary sheets is reduced; and a slicing step of slicing a multilayer cross section of the laminate.

This Nonprovisional application claims priority under 35 U.S.C. § 119 on Patent Application No. 2024-135617 filed in Japan on Aug. 15, 2024, the entire contents of which are hereby incorporated by reference.

### TECHNICAL FIELD

The present invention relates to a method for producing a thermally conductive sheet.

### BACKGROUND ART

A technique for preventing or reducing temperature increases by attaching a heat-dissipating body to a heat-generating body such as an electronic component is conventionally known. In a case where this heat-dissipating body is used, a member that is in sheet form and that has thermal conductivity (thermally conductive sheet) is used to efficiently transmit heat from the heat-generating body to the heat-dissipating body. Further, the thermally conductive sheet is required to have adhesion to an adherend.

As a method for producing thermally conductive sheet that has thermal conductivity and adhesion, known is a method including the steps of: forming a laminate by stacking primary sheets containing graphite particles and an organic polymer compound; and obtaining a thermally conductive sheet by slicing the laminate (Patent Literatures 1 to 4).

### CITATION LIST

### Patent Literature

[Patent Literature 1]
Japanese Patent No. 5381102
[Patent Literature 2]
Japanese Patent No. 6341303
[Patent Literature 3]
Japanese Patent No. 6881429
[Patent Literature 4]
Japanese Patent Application Publication Tokukai No. 2023-016528

### SUMMARY OF INVENTION

### Technical Problem

In recent years, there is a demand for further improvement in the thermal conductivity of a thermally conductive sheet. Here, as a method of further improving the thermal conductivity of a thermally conductive sheet, known is a method in which thickness of the thermally conductive sheet is reduced. However, in a thermally conductive sheet which is produced by a conventional method like a method disclosed in any of Patent Literatures 1 to 4 and which has a small thickness, a hole, that is, a portion where the thermally conductive sheet cannot come in contact with an adherend is produced. Accordingly, in the thermally conductive sheet, a temporary attachment property and adhesion with respect to the adherend may be deteriorated.

In the light of the above-described matters, an object of an aspect of the present invention is to provide a method for producing a thermally conductive sheet which can (i) improve thermal conductivity of the thermally conductive sheet without reducing thickness of the thermally conductive sheet, (ii) improve adhesion of the thermally conductive sheet to an adherend, and (iii) make it possible to prevent deterioration of the adhesion even in a case where the thickness is reduced. In other words, an object of an aspect of the present invention is to improve thermal conductivity, a temporary attachment property, and adhesion of a thermally conductive sheet that is produced and to produce a thermally conductive sheet that has excellent thermal conductivity, an excellent temporary attachment property, and excellent adhesion.

### Solution to Problem

In order to solve the above problem, a method in accordance with an embodiment of the present invention for producing a thermally conductive sheet includes: a primary sheet forming step of obtaining a primary sheet by forming, in sheet form, a mixture containing graphite particles (A), an organic polymer compound (B), and a solvent;
a laminate forming step of obtaining a primary sheet laminate, by stacking a plurality of the primary sheets while applying pressure so that thickness of the primary sheets is reduced; and
a slicing step of obtaining a thermally conductive sheet by slicing a multilayer cross section of the primary sheet laminate.

### Advantageous Effects of Invention

An aspect of the present invention makes it possible to produce a thermally conductive sheet that has excellent thermal conductivity, an excellent temporary attachment property, and excellent adhesion.

### BRIEF DESCRIPTION OF DRAWINGS

FIG. 1 is an X-ray diffraction (XRD) profile which was obtained by measuring an X-ray diffraction intensity with use of a two-dimensional X-ray diffraction device on a surface of a primary sheet obtained in Example 1.

FIG. 2 is an SEM image which shows a surface of a thermally conductive sheet obtained in Example 1 and which is obtained as a result of observing the surface with use of an SEM-EDX and performing mapping.

FIG. 3 is an image which shows a result of identification of carbon and which is obtained by observing, with use of the SEM-EDX, the surface of the thermally conductive sheet obtained in Example 1 and performing mapping.

FIG. 4 is an enlarged view of the SEM image shown in FIG. 2, and shows a state in which (i) a 500 μm×50 μm area (area 1) including a region that appears darker than surrounding regions and (ii) a 500 μm×50 μm area (area 2) including no region that appears darker than surrounding regions are set in the surface.

### DESCRIPTION OF EMBODIMENTS

The following description will discuss embodiments of the present invention, but the present invention is not limited to the embodiments. The present invention is not limited to the configurations described below, but may be altered in various ways within the scope of the claims. The present invention also encompasses, in its technical scope, any embodiment or example derived by combining technical means disclosed in differing embodiments or examples. Further, it is possible to form a new technical feature by combining the technical means disclosed in the respective embodiments. Note that all academic documents and patent literatures cited herein are incorporated herein by reference. Any numerical range expressed as “A to B” herein means “not less than A but not more than B (i.e., a range from A to B which includes both A and B)” unless otherwise stated.

### [1. Method for Producing Thermally Conductive Sheet]

A method in accordance with an embodiment of the present invention for producing a thermally conductive sheet, includes: a primary sheet forming step of obtaining a primary sheet by forming, in sheet form, a mixture containing graphite particles (A), an organic polymer compound (B), and a solvent; a laminate forming step of obtaining a primary sheet laminate, by stacking a plurality of the primary sheets while applying pressure so that thickness of the primary sheets is reduced; and a slicing step of obtaining a thermally conductive sheet by slicing a multilayer cross section of the primary sheet laminate.

Hereinafter, the method in accordance with an embodiment of the present invention for producing a thermally conductive sheet is also referred to as “the present production method”. Further, the thermally conductive sheet which is produced by the present production method is also referred to as “the present thermally conductive sheet”. The following description will discuss in detail each step constituting the present production method.

### [1-1. Primary Sheet Forming Step]

The present production method includes a primary sheet forming step of obtaining a primary sheet by forming, in sheet form, a mixture containing graphite particles (A), an organic polymer compound (B), and a solvent.

Conventionally known as a method for the primary sheet forming step is a method in which a primary sheet is obtained by: melt-kneading the graphite particles (A), the organic polymer compound (B), and, if necessary, an additive(s) without adding a solvent; and forming a resultant kneaded product in sheet form. According to a result of verification by the inventors of the present invention, in a surface of the thermally conductive sheet produced with use of a primary sheet that had been produced by the method, there was no difference in carbon concentration.

In light of the above, the inventors of the present invention made diligent studies and produced a primary sheet with use of not a melt-kneaded product to which no solvent is added but a mixture containing the graphite particles (A), the organic polymer compound (B), and a solvent. As a result, the inventors of the present invention have found that it is possible to obtain, by providing the primary sheet for the laminate forming step and the slicing step, a thermally conductive sheet in which there is a difference in carbon concentration. In other words, the present thermally conductive sheet is a thermally conductive sheet in which there is a difference in carbon concentration.

Here, the thermally conductive sheet in which there is a difference in carbon concentration, in short, means that there are a portion where the content of the graphite particles (A) is large and a portion where the content of the organic polymer compound (B) is large. Therefore, according to the present production method, it is possible to produce a thermally conductive sheet in which: since there is a portion where the content of the graphite particles (A) is large, thermal conductivity is suitably improved; and since there is a portion where the content of the organic polymer compound (B) is large, a temporary attachment property and adhesion to an adherend is suitably improved.

Further, according to a result of verification by the inventors of the present invention, in a case where a primary sheet obtained by a conventional method is stacked while pressure is applied so that thickness is reduced in the laminate forming step, which will be described later, there were cases where portions of the graphite particles (A) contained in the primary sheet were chipped off and particle size of such graphite particles (A) was decreased. In such cases, due to such a decrease in particle size of the graphite particles (A), the thermal conductivity of a thermally conductive sheet produced decreased in some cases.

On the other hand, in the primary sheet forming step in the present production method, even in a case where pressure is applied to reduce the thickness, it is possible to suitably prevent the particle size from decreasing due to the above-described chipping of portions of the graphite particles (A) or to form a primary sheet having an internal structure in which there is room to reduce a degree of that reduction. Therefore, the present production method suitably prevents the thermal conductivity of the thermally conductive sheet from decreasing due to the decrease in particle size of the graphite particles (A) or suitably reduces a degree of decrease of the thermal conductivity in the thermally conductive sheet. As a result, it is possible to produce a thermally conductive sheet having suitably improved thermal conductivity.

It is not clear why use of the mixture leads to formation of the difference in carbon concentration. However, it is inferred that the solvent makes respective degrees of dispersion of the graphite particles (A) and the organic polymer compound (B) inside the primary sheet different from those in a surface of the primary sheet, and such a difference is reflected in the laminate. Further, it is inferred that in a process of applying a solution containing the graphite particles (A) and the organic polymer compound (B) and then heating and drying the solvent, the organic polymer compound (B) moves to a surface layer of the primary sheet, and after lamination, a portion where the carbon concentration is low exists. Furthermore, it is also inferred that, when pressing is performed in the laminate forming step, the organic polymer compound (B) may be exuded to a boundary between primary sheets. In addition, a reason why use of the mixture makes it possible to form a primary sheet having the internal structure in which there is the room to reduce the degree of the reduction of the particle size as described above is unclear. However, with regard to the reason, it is inferred that the internal structure in which there is the above-described room is formed because each of the degrees of dispersion of the graphite particles (A) and the organic polymer compound (B) inside the primary sheet is different from that in the surface of the primary sheet. Note that an embodiment of the present invention is not, however, limited to such an inference.

### (Graphite Particles (A))

For the primary sheet forming step, a mixture containing the graphite particles (A) is provided. This makes it possible to produce a thermally conductive sheet including the graphite particles (A) by the present production method. Here, in the present thermally conductive sheet, the graphite particles (A) that are thermally conductive are dispersed. Accordingly, the thermal conductivity of the present thermally conductive sheet is improved, and this reduces thermal resistance of the present thermally conductive sheet.

The graphite particles (A) that is provided for the primary sheet forming step may have a shape that is either spherical or non-spherical. From the viewpoint that the graphite particles (A) being easily oriented make it possible to improve the thermal conductivity in an orientation direction of the graphite particles (A) of the present thermally conductive sheet and thus the thermal resistance of the present thermally conductive sheet in the orientation direction can be reduced, the graphite particles (A) preferably have a non-spherical shape. Note that only one type of graphite particles (A) may be used, or two or more types of graphite particles (A) may be used in combination.

The graphite particles (A) having a non-spherical shape have a shape that is not particularly limited. For example, the shape can be a plate-like shape such as a scale-like shape or a flaky shape; a spheroidal shape; a needle shape; a rod shape; a fibrous shape; or an irregular shape. In a case where the graphite particles (A) have a non-spherical shape, the graphite particles (A) are easily oriented and also, a contact between particles is easily maintained. This makes it possible to further improve the thermal conductivity in the orientation direction, so that the thermal resistance in the orientation direction can be further reduced. From this viewpoint, among others, the graphite particles (A) more preferably have a plate-like shape such as a scale-like shape or a flaky shape.

In the present specification, “spherical shape” means a perfectly spherical shape or a spheroidal shape having an aspect ratio of 1.0 to 1.5, in other words, a perfectly spherical shape having an aspect ratio of 1.0 or a spheroidal shape having an aspect ratio of more than 1.0 and not more than 1.5, and does not necessarily need to be a perfectly spherical shape. Note that the aspect ratio in a case where the graphite particles (A) have a “spherical shape” means a ratio denoted by the major axis/the minor axis. Further, “non-spherical shape” means a shape different from the “spherical shape”, i.e., a shape having an aspect ratio of more than 1.5. Note that “spheroidal shape” means an ellipsoidal shape obtained by rotating an ellipse, such as the shape of a rugby ball.

In the graphite particles (A) having a “non-spherical shape”, the aspect ratio means a ratio of a maximum length to a minimum length (maximum length/minimum length) of the graphite particles (A). For example, in a case where the shape is a plate-like shape, the minimum length of the graphite particles (A) is thickness, and the aspect ratio is a ratio of the maximum length to a thickness (maximum length/thickness) of the graphite particles (A). The aspect ratio can be determined by: observing a sufficient number of (e.g., not less than 10) graphite particles (A) with use of a scanning electron microscope; calculating the major axis/the minor axis or the maximum length/the minimum length of each of the graphite particles (A); and obtaining, as the aspect ratio, an average value of calculated values of the major axis/the minor axis or calculated values of the maximum length/the minimum length.

In a case where two or more types of graphite particles (A) are used, the aspect ratio is an average aspect ratio calculated by performing weighted average calculation on aspect ratios of the respective types of graphite particles (A).

The aspect ratio of the graphite particles (A) is preferably not less than 10, more preferably not less than 20, even more preferably not less than 40, and particularly preferably not less than 70, from the viewpoint of improving the thermal conductivity in the orientation direction. Although an upper limit of the aspect ratio is not particularly limited, the aspect ratio is normally not more than 1000. In a case where the graphite particles (A) have an aspect ratio of not less than 10, the thermal conductivity in the thickness direction of the thermally conductive sheet can be improved by orienting the graphite particles (A) in the thickness direction of the thermally conductive sheet. This can consequently further reduce the thermal resistance in the thickness direction of the thermally conductive sheet. Thus, an aspect ratio of not less than 10 is preferable.

An upper limit value of the average value of the short axis or the minimum length of the graphite particles (A) is preferably not more than 5 μm, more preferably not more than 3 μm, and even more preferably not more than 1 μm. In a case where the average value of the short axis or the minimum length of the graphite particles (A) is as small as not more than 5 μm, the density of the primary sheet obtained in the primary sheet forming step can be controlled to a lower value. As a result, in the present production method, a primary sheet having a lower density is provided for the laminate forming step, which will be described later, so that it is possible to produce a thermally conductive sheet in which the graphite particles (A) are more suitably oriented during lamination and it is possible to produce a thermally conductive sheet having further improved thermal conductivity. On the other hand, a lower limit value of the average value of the short axis or the minimum length of the graphite particles (A) is not particularly limited, and may be, for example, not less than 0.005 μm.

Examples of the graphite particles (A) include particles of, for example, scale-like graphite, scaly graphite, earthy graphite, artificial graphite, flaky graphite, acid-treated graphite, expanded graphite, or carbon fiber flakes.

The lower limit value of the average particle size of the graphite particles (A) is preferably not less than 50%, more preferably not less than 55%, and even more preferably not less than 608, relative to the thickness of the present thermally conductive sheet. Further, the upper limit value of the average particle size of the graphite particles is preferably not more than 100%, more preferably not more than 958, and even more preferably not more than 90%, with respect to the thickness of the present thermally conductive sheet. In a specific example, the average particle size of the graphite particles (A) is preferably 20 μm to 1000 μm, more preferably 30 μm to 500 μm, and particularly preferably 40 μm to 240 μm relative to the thickness of the present thermally conductive sheet. Note here that the average particle size of the graphite particles (A) is a value determined by a laser diffraction/scattering particle size distribution analyzer (LA-920, manufactured by HORIBA, Ltd.). Further, the thickness of the present thermally conductive sheet is measured by a well-known method, and is, for example, measured by a method described in Examples.

In a case where the average particle size of the graphite particles (A) is not less than 50% relative to the thickness of the present thermally conductive sheet, it is easy for the graphite particles (A) to be oriented in a desired direction in the thermally conductive sheet to form a good heat transfer path. Further, in a case where the upper limit of the average particle size of the graphite particles (A) is in the above-described range, the graphite particles are exposed on a surface of the thermally conductive sheet. This allows heat transfer from a heat-generating body to the thermally conductive sheet to be better when the thermally conductive sheet is brought into contact with the heat-generating body.

### (Organic Polymer Compound (B))

In the primary sheet forming step, it is possible to produce a thermally conductive sheet including the organic polymer compound (B) by the present production method by providing the mixture including the organic polymer compound (B). Here, in the present thermally conductive sheet, the organic polymer compound (B) not only functions as a binder but also improves flexibility of the thermally conductive sheet. Therefore, the present thermally conductive sheet can cause a heat-generating body and a heat-dissipating body to adhere to each other well.

The organic polymer compound (B) is not particularly limited and can be an organic polymer compound that is ordinarily used in a thermally conductive sheet.

Examples of the organic polymer compound (B) include an acrylic ester-based resin, a resin the main chain of which consists of repeated siloxane bonds (silicone resin), a resin which has rubber elasticity at room temperature (elastomer resin), an epoxy resin, a fluorine resin, polyolefin, polyvinyl chloride, polyvinylidene chloride, polyvinyl acetate, an ethylene-vinyl acetate copolymer, polyvinyl alcohol, polyacetal, polyethylene terephthalate, polybutylene terephthalate, polyethylene naphthalate, polystyrene, polyacrylonitrile, polyphenylene ether, modified polyphenylene ether, aliphatic polyamides, aromatic polyamides, polyamideimide, polycarbonate, polyphenylene sulfide, polysulfone, polyether sulfone, polyether nitrile, polyether ketone, polyketone, polyurethane, a liquid crystal polymer, and an ionomer. One type of these organic polymer compounds may be used alone, or two or more types may be used in combination.

The organic polymer compound (B) may be either solid or liquid at normal temperature. Note that “normal temperature” refers to 20° C. in the present specification.

Respective ranges of a Tg and a weight average molecular weight of the organic polymer compound (B) are preferably the same as preferable ranges of a Tg and a weight average molecular weight of an acrylic ester-based resin which will be described later. This allows the thermally conductive sheet to yield an effect that is similar to an effect obtained in a case where the acrylic ester-based resin has a Tg and a weight average molecular weight in the preferable ranges.

### <Acrylic Ester-Based Resin>

The organic polymer compound (B) preferably contains an acrylic ester-based resin. As the acrylic ester-based resin, one type of acrylic ester-based resin may be used alone, or two or more types may be used in combination.

The acrylic ester-based resin includes: a polymer of monomer components that contain at least one type of acrylic monomer selected from the group consisting of (meth)acrylic acids and (meth)acrylic esters; and a copolymer of the acrylic monomer and another monomer. Note here that “(meth)acrylic” is intended to include both “methacrylic” and “acrylic” in the present specification. Examples of the (meth)acrylic esters include methyl (meth)acrylate, ethyl (meth)acrylate, n-butyl (meth)acrylate, isobutyl (meth)acrylate, 2-ethylhexyl (meth)acrylate, and cyclohexyl (meth)acrylate.

Examples of the another monomer include acrylonitrile, glycidyl methacrylate, and 2-chloroethylvinyl ether. Note that acrylic rubber is obtained by copolymerizing a (meth)acrylic ester with, for example, acrylonitrile or 2-chloroethylvinyl ether. In the present specification, the acrylic rubber is considered to be included in the acrylic ester-based resin although the acrylic rubber is also classified into elastomer resin, which will be described later.

More preferable examples of the acrylic ester-based resin include an acrylic ester-based resin that contains butyl acrylate and/or 2-ethylhexyl acrylate as a monomer(s), a total amount of which is not less than 50% by weight relative to a total amount of monomer components. The acrylic ester-based resin is preferable because: the present thermally conductive sheet can easily obtain high flexibility; chemical stability and processability are excellent; and adhesiveness can be easily controlled. Further, in view of long-term adhesion retention and film strength of the present thermally conductive sheet, it is preferable to include, in the acrylic ester-based resin, a crosslinked structure in a range that does not impair flexibility. The crosslinked structure can be included by, for example, reacting a compound having an isocyanate group with a polymer having a hydroxyl group. Alternatively, the crosslinked structure can be included by, for example, reacting a compound having an epoxy group with a polymer having a carboxyl group.

A content of the acrylic ester-based resin relative to the total weight of the organic polymer compound (B) is preferably not less than 15% by weight, more preferably not less than 20% by weight, even more preferably not less than 25% by weight, and particularly preferably not less than 30% by weight. For example, the content of the acrylic ester-based resin can be 100% by weight relative to the total weight of the organic polymer compound (B).

The acrylic ester-based resin has a Tg of preferably not higher than −35° C., more preferably not higher than −50° C., and even more preferably not higher than −60° C. In a case where the acrylic ester-based resin has a Tg of not higher than −35° C., the acrylic ester-based resin can easily flow in the present thermally conductive sheet in bonding in a hot press machine. This allows the present thermally conductive sheet to have higher wettability to an adherend bonded thereto and have higher adhesion to the adherend. A lower limit value of the Tg of the acrylic ester-based resin is not particularly limited, and is exemplified by not lower than −150° C. The “Tg” described in the present specification can be calculated by, for example, a method described in Examples.

The acrylic ester-based resin may be either solid or liquid at normal temperature t under normal pressure. In particular, the acrylic ester-based resin is preferably liquid at normal temperature under normal pressure.

In the present specification, “normal pressure” refers to 1 atm. In other words, the acrylic ester-based resin has a melting point of preferably not higher than 20° C. Note that “melting point” described in the present specification is a melting point under normal pressure (1 atm). Further, in the present specification, “being liquid” means that, when a target resin is held in a container such as a bottle or a can at room temperature (20° C.) and the container is tilted, the resin flows. In addition, the resin may be in the form of a resin lump.

The acrylic ester-based resin has a weight average molecular weight of preferably not less than 50,000, more preferably not less than 150,000, and even more preferably not less than 250,000. In a case where the acrylic ester-based resin has a weight average molecular weight of as high as not less than 50,000, it is difficult for the acrylic ester-based resin to flow in the present thermally conductive sheet when an external force is applied (i) during release of a press plate after hot pressing during bonding and (ii) after bonding. This allows the present thermally conductive sheet to have higher adhesion to an adherend.

The acrylic ester-based resin has a weight average molecular weight of preferably not more than 3,000,000, more preferably not more than 2,000,000, and even more preferably not more than 1,500,000. In a case where the acrylic ester-based resin has a weight average molecular weight of not more than 3,000,000, the acrylic ester-based resin can easily flow in the present thermally conductive sheet in bonding in a hot press machine. This allows the present thermally conductive sheet to have higher wettability to an adherend bonded thereto and have higher adhesion to the adherend.

The weight average molecular weight described in the present specification can be measured with use of a calibration curve of standard polystyrene by, for example, gel permeation chromatography of a measurement target object.

The organic polymer compound preferably contains an acrylic ester-based resin having a functional group. In the present specification, the acrylic ester-based resin having a functional f group means that an acrylic ester-based resin contains a polymer of monomer components which include a monomer having a functional group.

The functional group has a function of binding the plurality of graphite particles (A). Thus, the acrylic ester-based resin having the functional group makes it possible to form the mixture in sheet form, so that the present thermally conductive sheet containing the mixture can be more easily provided. Further, there is a case where the functional group interacts with a substance of which a surface of an adherend is made, and contributes to adhesion between the present thermally conductive sheet and the adherend. In that case, adhesion between the present thermally conductive sheet and the adherend is considered to be also improved.

A type of the functional group is not particularly limited provided that the functional group has a function of binding the plurality of graphite particles (A). The functional group may be one type of functional group or two or more types of functional groups. The functional group can be at least one group selected from, for example, a hydroxyl group, a carboxyl group, and an epoxy group. The functional group is preferably a hydroxyl group and/or a carboxyl group, and more preferably a hydroxyl group. For example, the type of the functional group can be identified by a known method such as structure analysis which is carried out with respect to the acrylic ester-based resin and in which NMR or the like is used.

The monomer having the functional group is not particularly limited, and preferable examples thereof include 2-hydroxyethyl (meth)acrylate, 3-hydroxypropyl (meth)acrylate, 4-hydroxybutyl (meth)acrylate, 2-hydroxy-1-methyl (meth)acrylate, acrylic acid, methacrylic acid, and glycidyl (meth)acrylate. Among these, the monomer having the functional group more preferably contains 2-ethylhexyl acrylate. In other words, the acrylic ester-based resin more preferably contains a copolymer containing 2-ethylhexyl acrylate as a monomer.

In an embodiment of the present invention, in a case where a content of the functional group relative to a total weight of the acrylic ester-based resin is high, graphite particles (A) more suitably bind to each other via the acrylic ester-based resin in the present thermally conductive sheet. As a result, the present thermally conductive sheet has higher graphite binding capacity. In the following description, the content of the functional group relative to the total weight of the acrylic ester-based resin is referred to as “content C of a functional group”. Note that the content C of the functional group is a total amount of a content A of a functional group described later and a content B of a functional group described later.

A preferable range of the content C of the functional group is not less than 0.001 mmol/g, and not more than 0.410 mmol/g. The preferable range of the content C of the functional group can vary in accordance with, for example, a type of the functional group and a type of the graphite particles (A). For example, in a case where the functional group is at least one selected from a hydroxyl group, a carboxyl group, and an epoxy group, the content C of the functional group is preferably not less than 0.001 mmol/g, more preferably not less than 0.010 mmol/g, and even more preferably not less than 0.090 mmol/g from the viewpoint of further improving the graphite binding capacity. The content of the functional group can be expressed not only in a unit of “mmol/g” but also in a unit of “KOH mg/g”, which is commonly used. Specifically, for example, in a case where the functional group is at least one selected from a hydroxyl group, a carboxyl group, and an epoxy group, the content C of the functional group is preferably not less than 0.056 KOH mg/g, more preferably not less than 0.56 KOH mg/g, and even more preferably not less than 5.05 KOH mg/g.

The functional group can also ordinarily form a bond with a water molecule. Thus, in a case where the content C of the functional group is in a range of not more than a predetermined value, the affinity of the acrylic ester-based resin to water is reduced, so that moisture absorbency is also reduced. As a result, in the present thermally conductive sheet, the moisture absorbency is controlled in a suitable range, so that the thermally conductive sheet has further improved adhesion after maintained at high temperature.

For example, in a case where the functional group is a hydroxyl group, from the viewpoint of further improving the adhesion after maintaining the thermally conductive sheet at high temperature, the content C of the functional group is preferably not more than 0.371 mmol/g, more preferably not more than 0.340 mmol/g, and even more preferably not more than 0.300 mmol/g. In a case where the functional group is a hydroxyl group and the content C of the functional group is expressed in the unit of “KOH mg/g”, the content C of the functional group is preferably not more than 20.76 KOH mg/g, more preferably not more than 19.08 KOH mg/g, and even more preferably not more than 16.83 KOH mg/g.

For example, in a case where the functional group is a carboxyl group, from the viewpoint of further improving the adhesion after maintaining the thermally conductive sheet at high temperature, the content C of the functional group is preferably not more than 0.410 mmol/g, more preferably not more than 0.360 mmol/g, and even more preferably not more than 0.300 mmol/g. In a case where the functional group is a carboxyl group and the content C of the functional group is expressed in the unit of “KOH mg/g”, the content C of the functional group is preferably not more than 23.00 KOH mg/g, more preferably not more than 20.20 KOH mg/g, and even more preferably not more than 16.83 KOH mg/g.

Note that conversion from mmol/g to KOH mg/g is calculated by multiplying mmol/g by 56.1056 mg/mmol.

A method for measuring the content C of the functional group is exemplified by, but not particularly limited to, a method including steps (1) to (3) below.

(1) A known method is used to extract the acrylic ester-based resin from the thermally conductive sheet and measure a total weight (unit: g) of the extracted acrylic ester-based resin.

(2) ¹HNMR or the like is used to measure a substance amount (unit: mmol) of the functional group in the acrylic ester-based resin extracted in step (1).

(3) The content (unit: mmol/g) of the functional group is calculated by dividing, by the total weight of the acrylic ester-based resin which total weight has been measured in step (1), the substance amount of the functional group in the acrylic ester-based resin which substance amount has been measured in step (2).

Assume a case in which weight average molecular weights of all polymers contained in the acrylic ester-based resin, a content of a monomer having the functional group in all monomers constituting the polymers, and a content ratio of each of the polymers are known. In this case, on the basis of those, the content C of the functional group can also be calculated.

The acrylic ester-based resin more preferably contains an acrylic resin having a functional group and an acryl block copolymer. The acrylic resin having the functional group may be composed of one type of acrylic resin having a functional group or may be a mixture of two or more types of acrylic resins having a functional group. The acryl block copolymer may be composed of one type of acryl block copolymer or may be a mixture of two or more types of acryl block copolymers.

### (Solvent)

The mixture that is provided for the primary sheet forming step contains a solvent. Examples of the solvent include, but are not limited to: aromatic hydrocarbon solvents such as toluene and xylene; ester-based solvents such as ethyl acetate and butyl acetate; ketone-based solvents such as methyl ethyl ketone and methyl isobutyl ketone (MIBK); and cellosolve-based solvents such as butyl cellosolve, phenyl cellosolve, and dimethyl cellosolve. An amount of the solvent is preferably such that the total concentration of the solid content of the mixture, that is, a total concentration of the graphite particles (A), the organic polymer compound (B), and the additive(s) is within a preferable range which will be described later. The amount of the solvent is preferably such that the total concentration is 10% by weight to 40% by weight, and is more preferably such that the total concentration is 20% by weight to 40% by weight. The primary sheet that is produced at this concentration is preferable because there is a moderate space between the graphite particles, so that orientation of the graphite particles is improved during sheet production and lamination pressing.

### (Mixture)

In an embodiment of the present invention, the mixture has a solid content concentration of preferably not less than 10% by weight but not more than 40% by weight, more preferably not less than 10% by weight but not more than 37% by weight, and even more preferably not less than 15% by weight but not more than 35% by weight relative to the total weight of the mixture. Adjustment of the solid content concentration of the mixture in the foregoing preferable range leads to a moderate space provided between the graphite particles, so that orientation of the graphite particles is improved during sheet production and lamination pressing. As a result, the thermal conductivity of the present thermally conductive sheet can be further improved. Thus, the above-described range is preferable. Note that the solid content consists of the graphite particles (A), the organic polymer compound (B), and, optionally, an additive(s) which will be described later.

In an embodiment of the present invention, a lower limit value of the content of the graphite particles (A) is preferably more than 50% by weight, more preferably not less than 50.1% by weight, and even more preferably not less than 50.3% by weight relative to the total weight of the solid content of the mixture. The content of the graphite particles (A) relative to the total weight of the solid content of the mixture is preferably more than 50% by weight, because thermal conductivity which is improved by the present thermally conductive sheet is exhibited. The upper limit value of the content of the graphite particles (A) in the mixture is preferably not more than 65% by weight, more preferably not less than 60% by weight, and even more preferably not less than 55% by weight, relative to the total weight of the solid content of the mixture. It is preferable that the content of the graphite particles (A) be not more than 65% by weight, because the flexibility and the adhesion of the present thermally conductive sheet can be further improved.

In an embodiment of the present invention, the content of the organic polymer compound (B) in the mixture is preferably not less than 35% by weight but less than 50% by weight, more preferably not less than 40% by weight but not more than 49.9% by weight, and even more preferably not less than 45% by weight but not more than 49.7% by weight, relative to the total weight of the mixture. In a case where the content of the organic polymer compound (B) is not less than 35% by weight, it is possible to improve the flexibility of the present thermally conductive sheet and allow for good adhesion between a heat-generating body and a heat-dissipating body via the present thermally conductive sheet. Thus, the content of the organic polymer compound (B) is preferably not less than 35% by weight. A higher content of the organic polymer compound (B) in a range of less than 50% by weight is preferable because the graphite particles (A) can be suitably immobilized, and higher adhesion between the present thermally conductive sheet and the semiconductor and/or the spreader is achieved.

The mixture may contain, if necessary, one or more additives such as a plasticizer, a flame retardant, an anti-aging agent, a thermal stabilizer, a colorant, an antistatic agent, a tackifier, and/or a filler different from the graphite particles (A). Further, the plasticizer can be, for example, polybutene and/or a phosphorus-based flame retardant. In a case where the thermally conductive sheet contains polybutene and/or a phosphorus-based flame retardant, an effect of improving wettability to silicon and/or a spreader and reducing thermal resistance is exhibited. The flame retardant can be, for example, a phosphorus-based flame retardant. A phosphorus-based flame retardant has a function of preventing or reducing burning of a resin.

In a case where the mixture contains the additive(s), a content of the additive(s) only needs to be in a range that does not impair an effect of an embodiment of the present invention and is not particularly limited. A preferable content t of the additive(s) is, for example, not more than 50% by weight relative to the total weight of the solid content of the mixture.

Examples of the anti-aging agent include a phenol-based anti-aging agent and an amine-based anti-aging agent. An amount of the anti-aging agent mixed is preferably 0.1 parts by weight to 10 parts by weight, and more preferably 0.2 parts by weight to 8 parts by weight, relative to a total weight of 100 parts by weight of the organic polymer compound (B).

Note that the content of the graphite particles (A), the organic polymer compound (B), and the additive(s) relative to the total weight of the solid content of the mixture can be the same as the content of the graphite particles (A), the organic polymer compound (B), and the additive(s) relative to the total weight of the present thermally conductive sheet.

### (Method for Forming Primary Sheet)

The primary sheet forming step is preferably a step of forming the primary sheet by application of the mixture. This step is referred to as a scraping method. In this method, the mixture is poured into a mold, scraped, and dried, so that a primary sheet is obtained. This method is preferable since a thermally conductive sheet having a surface in which there is a difference in carbon concentration can be easily obtained. In the primary sheet forming step, the solvent is removed.

The primary sheet forming step is preferably the step of forming a primary sheet by applying the mixture and then drying the mixture. According to this configuration, the solvent can be further removed because drying is carried out separately after application of the mixture. It is therefore possible to obtain a thermally conductive sheet in which a residual amount of the solvent is minimized. Examples of an application method include the scraping method described earlier, and examples of a drying method include air drying.

A thickness of the composition to be formed in sheet form, that is, a thickness of the primary sheet obtained in the primary sheet forming step is preferably more than 20 times, and more preferably 20 times to 100 times the average particle size of the graphite particles (A). In a case where the thickness is in the above range, a sheet having high strength can be obtained and graphite particles are likely to be oriented after lamination pressing. Thus, the thickness in the above range is preferable. Further, since a thermally conductive sheet having a surface in which there is a difference in carbon concentration can be easily obtained, the thickness in the above range is preferable.

### (Physical Properties of Primary Sheet)

An upper limit value of the density of the primary sheet obtained in the primary sheet forming step is preferably not more than 1.2 g/cm³, more preferably not more than 1.0 g/cm³, and even more preferably not more than 0.5 g/cm³. In a case where the value of the density of the primary sheet is as low as not more than 1.2 g/cm³, it is possible to produce, by providing the primary sheet whose density is lower for the laminate forming step which will be described later, a thermally conductive sheet in which the graphite particles (A) are more suitably oriented during lamination and in which the thermal conductivity is further improved. Further, in the lamination, the sheet is easily compressed, so that air contained inside and between the sheets can be released. As a result, it is possible to obtain a thermally conductive sheet in which there are no holes or there are a small number of holes. Further, a lower limit value of the density of the primary sheet is not particularly limited, and is, for example, not less than 0.1 g/cm³. The density of the primary sheet can be controlled by, for example, adjusting (i) the mixture used and the amount of solid content of the mixture and (ii) the thickness of the primary sheet.

An upper limit value of the tensile strength of the primary sheet obtained in the primary sheet forming step is preferably not more than 0.5 MPa, more preferably not more than 0.4 MPa, and even more preferably not more than 0.3 MPa. In a case where a value of the tensile strength of the primary sheet is as low as not more than 0.5 MPa, the sheet is easily compressed and the air contained inside and between the sheets can be released in the lamination. As a result, it i possible to obtain a thermally conductive sheet in which there are no holes or there are a small number of holes. Further, a lower limit value of the tensile strength of the primary sheet is preferably not less than 0.01 MPa, more preferably not less than 0.02 MPa, and even more preferably not less than 0.03 MPa in view of the strength of the primary sheet and the strength of the present thermally conductive sheet. A method for measuring the tensile strength of the primary sheet is not particularly limited. A known method can be used as the method for measuring the tensile strength. The method can be, for example, a method described in Examples.

In a case where the degree of orientation of the graphite particles (A) in the primary sheet obtained in the primary sheet forming step is low to some extent, the degree of orientation of the graphite particles (A) also becomes low to some extent and the orientation of the graphite particles (A) is disordered to some extent in the present thermally conductive sheet. Here, in a case where the orientation of the graphite particles (A) is disordered to some extent in the present thermally conductive sheet, the thermally conductive sheet easily conforms to the adherend when force is applied to the present thermally conductive sheet during temporary attachment and attachment to an adherend. In a case where the degree of orientation of the graphite particles (A) in the primary sheet is low to some extent, the present production method can produce the present thermally conductive sheet which exhibits a superior temporary attachment property and superior adhesion.

On the other hand, in a case where the degree of orientation of the graphite particles (A) in the primary sheet is high to some extent, the degree of orientation of the graphite particles (A) in the present thermally conductive sheet is also high to some extent. In this case, the graphite particles (A) are suitably oriented in the thickness direction of the present thermally conductive sheet. This causes the present thermally conductive sheet to have decreased thermal resistance and exhibit superior thermal conductivity. In a case where the degree of orientation of the graphite particles (A) in the primary sheet is high to some extent, the present production method can produce the present thermally conductive sheet which exhibits superior thermal conductivity.

Further, examples of an index that represents a degree of in-plane orientation of the graphite particles (A) in the primary sheet includes a ratio of a maximum value and a minimum value of a (002) peak of the graphite particles in a β profile, which is obtained by: (i) extracting the (002) peak of the graphite particles (A) from an X-ray diffraction (XRD) profile which is obtained by measuring an X-ray diffraction intensity with use of a two-dimensional XRD device on a surface of the primary sheet and (ii) plotting an intensity distribution in a circumferential direction.

In the following description, the ratio of the maximum value and the minimum value of the (002) peak of the graphite particles in the β profile is also referred to as “degree of in-plane orientation of (002) planes of the graphite particles”. A method for obtaining the X-ray diffraction profile is not particularly limited and can be a method in which a commercially available X-ray diffraction device is used, and more specifically, can be a method described in Examples. Further, a method for calculating the “degree of in-plane orientation of (002) planes of the graphite particles” from the XRD profile can be, for example, a method described in Examples.

From the viewpoint that the present thermally conductive sheet which exhibits the above-described superior temporary attachment property and superior adhesion can be produced, the “degree of in-plane orientation of (002) planes of the graphite particles” in the primary sheet is preferably not more than 4.0, more preferably not more than 3.0, and even more preferably not more than 2.0. Further, from the viewpoint that the present thermally conductive sheet which exhibits the above-described superior thermal conductivity can be produced, the lower limit value of the “degree of in-plane orientation of (002) planes of the graphite particles” in the primary sheet is preferably not less than 1.0.

### [1-2. Laminate Forming Step]

The present production method includes a laminate forming step of obtaining a primary sheet laminate, by stacking a plurality of the primary sheets while applying pressure so that thickness of the primary sheets is reduced. Here, pressure is applied to the primary sheets constituting the laminate so as to reduce the thickness. Such a primary sheet constituting the laminate is thinner than the primary sheet obtained in the primary sheet forming step, and has an altered internal structure. Hereinafter, the primary sheet constituting the laminate is also referred to as “primary sheet after pressure application” in order to distinguish the primary sheet constituting the laminate from the primary sheet obtained in the primary sheet forming step. Meanwhile, the primary sheet obtained in the primary sheet forming step is also referred to as “primary sheet prior to pressure application”.

In the laminate forming step, the primary sheet prior to pressure application is subjected to pressure application so that the thickness of the primary sheet is reduced, and is thus altered to a primary sheet after pressure application. In this case, as a result of the pressure application, the degree of orientation of the graphite particles (A) in the primary sheet prior to pressure application is changed to be high, so that the degree of orientation of the graphite particles (A) is improved in the primary sheet after pressure application. Thus, in the primary sheet after pressure application, the degree of orientation of the graphite particles (A) is high. Accordingly, the degree of orientation of the graphite particles (A) in the present thermally conductive sheet is also high, and thus, the present thermally conductive sheet has excellent thermal conductivity.

Further, holes (voids) in the primary sheet prior to pressure application are blocked by the pressure application. Accordingly, the size of the holes is reduced, the number of the holes is reduced, or the holes disappear. As a result, there are no holes in the primary sheet after pressure application, or even in a case where holes exist, the size of the holes is small and/or the number of the holes is small. Therefore, also in the present thermally conductive sheet, holes are not present or even in a case where holes are present, the size and/or the number of the holes is small. This prevents or reduces, in the present thermally conductive sheet, deterioration in adhesion between the present thermally conductive sheet and an adherend due to formation of the holes, that is, portions where the present thermally conductive sheet cannot come in contact with the adherend.

In view of the matters described above and the matters described in the above [1. Method for producing thermally conductive sheet] section, it can be understood that the present production method makes it possible to produce a thermally conductive sheet having excellent thermal conductivity, an excellent temporary attachment property, and excellent adhesion.

### (Lamination Method)

In the laminate forming step, a method for laminating the plurality of primary sheets is exemplified by, but not particularly limited to, a method in which a plurality of primary sheets are stacked and a method in which a primary sheet is folded. The primary sheet is preferably laminated with the graphite particles (A) aligned in a sheet surface. Further, lamination may be carried out under heating as appropriate. The temperature at that time is exemplified by, but not particularly limited to, 20° C. to 200° C. The number of the primary sheets stacked in the laminate forming step is not particularly limited provided that the number is plural, that is, two or more. An upper limit value of the number of the primary sheets stacked can be selected as appropriate according to the size, in a planar direction, of the thermally conductive sheet to be produced, and is not particularly limited. For example, the upper limit value of the number of primary sheets laminated can be not more than 50.

In an embodiment of the present invention, preferably, the primary sheet is planar and, in the laminate forming step, the laminate is obtained by stacking, in a normal direction to a planar surface of the primary sheet, the primary sheets that are each planar.

### (Pressure Application Method)

In an embodiment of the present invention, an aspect of pressure application in the laminate forming step is not particularly limited, and pressure may be applied one time or a plurality of times separately. More specifically, pressure may be applied every time a single primary sheet prior to pressure application is stacked, pressure may be applied for each plurality of primary sheets prior to pressure application, pressure may be applied after all primary sheets prior to pressure application are stacked, or pressure may be applied in combination of these aspects of pressure application. Preferable examples of the pressure application method include a method in which pressure is applied every time a single primary sheet prior to pressure application or a plurality of primary sheets prior to pressure application is/are stacked and additionally, pressure is applied after all primary sheets are stacked.

The pressure application method in the laminate forming step is not particularly limited provided that the pressure application method can apply pressure so that the thickness of the primary sheet prior to pressure application is reduced. It is possible to employ a known pressure application method, and, for example, a method described in Examples.

In an embodiment of the present invention, in the laminate forming step, pressure is applied so that, in a case where the thickness of the primary sheet prior to pressure application is set to 100%, the thickness of the primary sheet becomes preferably not more than 95%, more preferably not more than 708, and even more preferably not more than 50%. The above matter means that in the laminate forming step, pressure is applied so that the thickness of the primary sheet after pressure application becomes not more than the preferable upper limit described above. Pressure is applied so that the thickness of the primary sheet after pressure application becomes not more than the preferable upper limit described above. This suitably improves the degree of orientation of the graphite particles (A) in the primary sheet after pressure application and the present thermally conductive sheet. As a result, the present production method makes it possible to produce the present thermally conductive sheet that has superior thermal conductivity.

On the other hand, in the laminate forming step, in a case where the thickness of the primary sheet after pressure application is excessively reduced, portions of the graphite particles (A) in the primary sheet prior to pressure application are chipped off by the pressure application. As a result, the particle size of the graphite particles (A) may decrease. In that case, due to such a decrease in the particle size of the graphite particles (A), the thermal conductivity of the present thermally conductive sheet may deteriorate. Therefore, from the viewpoint of preventing a decrease in the thermal conductivity of the present thermally conductive sheet due to a decrease in particle diameter of the graphite particles (A) or reducing the degree of decrease in the thermal conductivity in the present thermally conductive sheet, it is preferable that the pressure be applied such that the thickness of the primary sheet after pressure application be maintained to be not less than a predetermined thickness. From the above viewpoint, specifically, in the laminate forming step, pressure is applied so that, in a case where the thickness of the primary sheet prior to pressure application is set to 100%, the thickness of the primary sheet becomes preferably not less than 5%, more preferably not less than 10%, and even more preferably not less than 158. The above matter means that in the laminate forming step, pressure is applied so that the thickness of the primary sheet after pressure application becomes not less than the preferable lower limit described above.

In an embodiment of the present invention, in the laminate forming step, a lower limit value of the pressure applied during pressure application to the primary sheet is preferably not less than 1 kg/cm², more preferably not less than 5 kg/cm², and even more preferably not less than 10 kg/cm². In a case where the pressure is not less than the preferable lower limit described above, the thickness of the primary sheet after pressure application can be suitably controlled in a range of not more than the preferable upper limit described above. As a result, the present production method makes it possible to produce the present thermally conductive sheet that has superior thermal conductivity.

In an embodiment of the present invention, in the laminate forming step, the upper limit value of the pressure applied during pressure application to the primary sheet is preferably not more than 100 kg/cm², more preferably not more than 70 kg/cm², and even more preferably not more than 50 kg/cm². In a case where the pressure is not more than the preferable upper limit described above, the thickness of the primary sheet after pressure application can be suitably controlled in a range of not less than the preferable lower limit described above. As a result, it is possible to suitably prevent a decrease in the thermal conductivity of the present thermally conductive sheet due to a decrease in particle size of the graphite particles (A).

Note that in a case where the pressure is applied a plurality of times separately, the primary sheet after pressure application and/or the pressure applied in the pressure application are preferably in the above described ranges at each pressure application.

### (1-3. Slicing Step)

The present production method includes a slicing step of obtaining a thermally conductive sheet by slicing a multilayer cross section of the primary sheet laminate.

An angle at which the multilayer cross section of the primary sheet laminate is sliced in the slicing step is not particularly limited. The angle at which the multilayer cross section of the primary sheet laminate is sliced is not more than an angle of 45°, more preferably an angle of 0° to 30°, and even more preferably an angle of 0° to 15° relative to the layer-stacking direction. By slicing at an angle of not more than 45° relative to the layer-stacking direction, it is possible to obtain a thermally conductive sheet that has excellent thermal conductivity.

A method for slicing the primary sheet laminate is exemplified by, but not particularly limited to, a multi-blade method, a laser processing method, a water jet method, and a knife processing method.

In an embodiment of the present invention, the multilayer cross section of the laminate is sliced in the slicing step so that the thickness of the thermally conductive sheet obtained becomes preferably not more than 150 μm, more preferably not more than 130 μm, and even more preferably not more than 110 μm. In the slicing step, in a case where the multilayer cross section of the laminate is sliced so that a thermally conductive sheet obtained has a small thickness in a range of not more than 150 μm, it is possible to further decrease the thermal resistance of the thermally conductive sheet and produce a thermally conductive sheet having superior thermal conductivity. Further, in an embodiment of the present invention, the multilayer cross section of the laminate is sliced in the slicing step so that a thermally conductive sheet obtained has a thickness of preferably not less than 30 μm, more preferably not less than 40 μm, and even more preferably not less than 50 μm. In the slicing step, in a case where the multilayer cross section of the laminate is sliced so that a thermally conductive sheet obtained has a large thickness in a range of not less than 30 μm, it is possible to produce a thermally conductive sheet that has a superior temporary attachment property and superior adhesion. Note that the thickness of the thermally conductive sheet obtained in the above-described slicing step means the thickness of the present thermally conductive sheet.

### [1-4. Physical Properties of Present Thermally Conductive Sheet]

In an embodiment of the present invention, the graphite particles (A) contained in the present thermally conductive sheet are different from graphite particles in a conventional production method in that in each step of the present production method, portions of the graphite particles (A) are not chipped off or are chipped off to a smaller degree. Thus, a decrease in the average particle size of the graphite particles (A) due to such chipping is also suitably prevented or a degree of the decrease in the average particle size is reduced. Therefore, the present production method suitably prevents a decrease in the thermal conductivity of the thermally conductive sheet due to a decrease in average particle size of the graphite particles (A) in the process of producing the thermally conductive sheet or suitably reduce the degree of the decrease in the thermal conductivity. As a result, it is possible to produce a thermally conductive sheet having a suitably improved thermal conductivity.

From the above-described viewpoint, in an embodiment of the present invention, the average particle size of the graphite particles (A) eluted with use of an eluent from the thermally conductive sheet is preferably not less than 50%, more preferably not less than 55%, and even more preferably not less than 60% of the thickness of the present thermally conductive sheet. The eluent can be any eluent selected from eluents which dissolve the organic polymer compound (B) and, in a case where the present thermally conductive sheet contains an additive(s), the additive(s), but which does not dissolve the graphite particles (A). The eluent is exemplified by, but not particularly limited to, methyl ethyl ketone. The average particle size, like the average particle size of the graphite particles (A) provided for the primary sheet forming step, is a value determined by a laser diffraction/scattering particle size distribution analyzer (LA-920, manufactured by HORIBA, Ltd.).

In an embodiment of the present invention, in an X-ray diffraction (XRD) profile which is obtained by measuring an X-ray diffraction intensity with use of a two-dimensional XRD device on a surface of the thermally conductive sheet, a peak representing the (002) plane of the graphite particles (A) has a half width of preferably 45° to 63°, more preferably 46° to 62°, and even more preferably 47° to 61°. In a case where the peak has a half width in the above preferable range, the present thermally conductive sheet has further decreased thermal resistance, i.e., superior thermal conductivity, a superior temporary attachment property, and superior adhesion. A method for measuring the half width of the peak is not particularly limited and can be a method described in Examples.

### <Recap>

An embodiment of the present invention includes any of the following features.

<1> A method for producing a thermally conductive sheet, comprising: a primary sheet forming step of obtaining a primary sheet by forming, in sheet form, a mixture containing graphite particles (A), an organic polymer compound (B), and a solvent;
a laminate forming step of obtaining a primary sheet laminate, by stacking a plurality of the primary sheets while applying pressure so that thickness of the primary sheets is reduced; and
a slicing step of obtaining a thermally conductive sheet by slicing a multilayer cross section of the primary sheet laminate.
   <2> The method according to <1>, wherein in the laminate forming step, the pressure is applied so that, in a case where the thickness of the primary sheet prior to application of the pressure is set to 100%, the thickness becomes not more than 95%.
   <3> The method according to <1> or <2>, wherein the primary sheet obtained in the primary sheet forming step has a density of not more than 1.2 g/cm³.
   <4> The method according to any one of <1> to <3>, wherein the thickness of the primary sheet obtained in the primary sheet forming step is more than 20 times an average particle size of the graphite particles (A).
   <5> The method according to any one of <1> to <4>, wherein the primary sheet is planar and, in the laminate forming step, the laminate is obtained by stacking the primary sheet that is planar in a normal direction to a planar surface of the primary sheet.
   <6> The method according to any one of <1> to <5>, wherein the mixture has a solid content concentration of not less than 10% by weight but not more than 40% by weight relative to a total weight of the mixture.
   <7> The method according to any one of <1> to <6>, wherein, in the laminate forming step, when the pressure is applied to the primary sheet, the pressure is not less than 1 kg/cm².
   <8> The method according to any one of <1> to <7>, wherein the mixture contains the graphite particles (A) in an amount of more than 50% by weight relative to a total weight of solid content of the mixture.
   <9> The method according to any one of <1> to <8>, wherein the graphite particles (A) have a short-axis average value or minimum-length average value of not more than 5 μm.
   <10> The method according to any one of <1> to <9>, wherein the graphite particles (A) have an average particle size that is not less than 50% relative to the thickness of the thermally conductive sheet.

<11> The method according to any one of <1> to <10>, wherein the graphite particles (A) have an aspect ratio of not less than 10.

<12> The method according to any one of <1> to <11>, wherein the primary sheet obtained in the primary sheet forming step has a tensile strength of not more than 0.5 MPa.
<13> The method according to any one of <1> to <12>, wherein, in a β profile which is obtained by (i) extracting a (002) peak of the graphite particles (A) from an X-ray diffraction (XRD) profile which is obtained by measuring an X-ray diffraction intensity with use of a two-dimensional XRD device on a surface of the primary sheet obtained in the primary sheet forming step and (ii) plotting an intensity distribution in a circumferential direction, a ratio of a maximum value and a minimum value of the (002) peak of the graphite particles in a β profile is not more than 4.0.
<14> The method according to any one of <1> to <13>, wherein in the slicing step, the multilayer cross section of the laminate is sliced so that the thickness of the thermally conductive sheet obtained becomes not more than 150 μm.
<15> The method according to any one of <1> to <14>, wherein, in an X-ray diffraction (XRD) profile which is obtained by measuring an X-ray diffraction intensity with use of a two-dimensional XRD device on a surface of the thermally conductive sheet, a peak representing a (002) plane of the graphite particles (A) has a half width of 45° to 63°.

### EXAMPLES

The following description will discuss an embodiment of the present invention in more detail with reference to Examples and Comparative Example. Note, however, that the present invention is not limited to these examples.

### [Evaluation Methods]

Evaluation methods in Examples and Comparative Example will be described below.

### <Thickness>

A 3 mm square piece was cut out from a primary sheet prior to pressure application or a thermally conductive sheet and used as an evaluation sample. The thickness in four corner parts and one central part of the evaluation sample was measured with use of a micrometer manufactured by Mitutoyo Corporation, and an average of obtained measurement values was regarded as the thickness of the primary sheet prior to pressure application or the thermally conductive sheet. Note here that “one central part” refers to the position of an intersection of two diagonal lines when diagonal lines are drawn from the four corner parts to diagonally located measurement sites.

Further, the thickness of a primary sheet laminate was measured by the same method as the thickness of the primary sheet or the thermally conductive sheet described above. Subsequently, the thickness of a primary sheet constituting the laminate, that is, the thickness of a primary sheet after pressure application was calculated by dividing the thickness of the primary sheet laminate by the number of primary sheets constituting the laminate. Thereafter, a ratio of the thickness of the primary sheet after pressure application in a case where the thickness of the primary sheet prior to pressure application was set to 100% was calculated.

### <Density of Primary Sheet Prior to Pressure Application>

The density of the primary sheet prior to pressure application was calculated by dividing, by a volume of the primary sheet prior to pressure application, a weight of the primary sheet prior to pressure application. A product of the thickness and an area of the primary sheet prior to pressure application was calculated. A value obtained by this calculation was regarded as the volume of the primary sheet prior to pressure application.

### <Tensile Strength of Primary Sheet Prior to Pressure Application>

A primary sheet prior to pressure application was punched out and shaped with use of a type-2 dumbbell die in accordance with JIS K6251, so that a sample piece was prepared. A tensile tester (Model 5565, a compact universal material tester manufactured by Instron Corporation) was used. The sample piece was pinched by the tensile tester at positions that are 1 cm apart from respective ends of the sample piece, and pulled at a tensile speed of 500 mm/min in a direction perpendicular to a normal line emanating from a surface of the sample piece at a temperature of 23° C. Thus, breaking strength (tensile strength) was measured. Measured were breaking strengths (tensile strengths) in two directions, one of which was a scraping direction and the other of which was a direction perpendicular to the scraping direction, during preparation of the primary sheet, and an average value of the breaking strengths was regarded as the tensile strength of the primary sheet prior to pressure application.

<Degree of in-Plane Orientation of (002) Planes of the Graphite Particles in Primary Sheet Prior to Pressure Application>

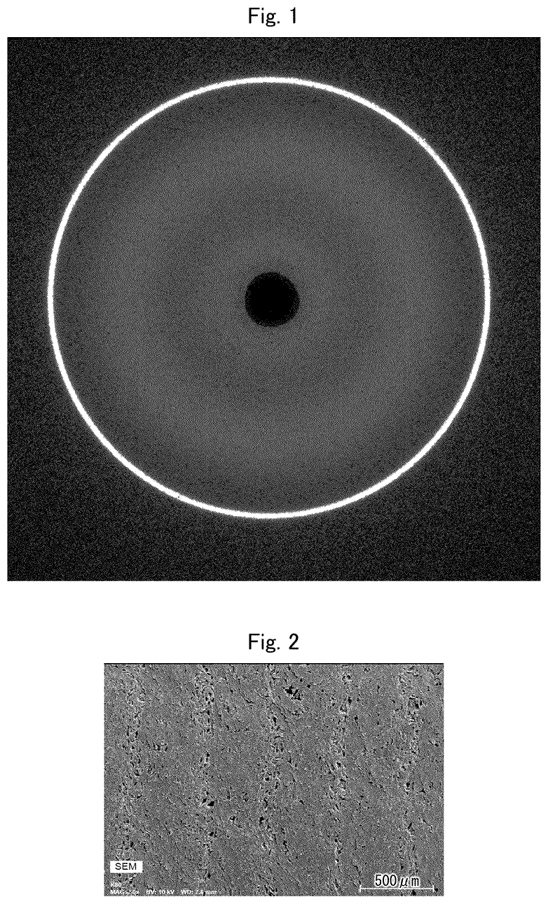

With use of a two-dimensional X-ray diffraction (XRD) device (Nano-Viewer small angle scattering measurement instrument, manufactured by Rigaku Corporation) on a surface of the primary sheet prior to pressure application, an XRD profile was obtained by measuring the X-ray diffraction intensity under conditions described in <XRD measurement conditions> below. A β profile was obtained by: extracting a (002) peak (2θ=26° to 29°) of the graphite particles (A) and plotting an intensity distribution in a circumferential direction. The degree of in-plane orientation of the (002) planes of the graphite particles (A) was calculated by dividing the maximum value by the minimum value in the β profiles. Note that FIG. 1 shows the XRD profile which was obtained in a case where a primary sheet prior to pressure application described in Example 1 was the subject of measurement.

### <XRD Measurement Conditions>

Tube: Cukα line, Output: 40 kV-30 mA,
Slit: 1st slit: 0.2 mm, 2nd slit: 0.1 mm, and 3rd slit: 0.25 mm,
Measurement method: transmission method,
Detector: PILATUS-100K,
Exposure time: 30 minutes (10 minutes×3 times), and
Camera length: 67 mm.

### <Average Particle Size of Graphite Particles (A)>

A laser diffraction/scattering particle size distribution analyzer (LA-920, manufactured by HORIBA, Ltd.) was used to measure an average particle size of the graphite particles (A) prior to use which would be provided for Examples and Comparative Example.

Further, from the thermally conductive sheet, the graphite particles (A) contained in the thermally conductive sheet were eluted by using, as an eluent, methyl ethyl ketone. The average particle size of the graphite particles (A) thus eluted was measured with use of the laser diffraction/scattering particle size distribution analyzer (LA-920, manufactured by HORIBA, Ltd.). The average particle size of the graphite particles (A) eluted, which was thus measured, was defined as the “average particle size of the graphite particles (A) eluted from the thermally conductive sheet”.

### <Presence/Absence of Holes>

Light was applied to the thermally conductive sheet from a backside of the thermally conductive sheet in order to visually check whether a hole(s) was present in the thermally conductive sheet.

<Presence/Absence of Portion where Carbon Content was Different>

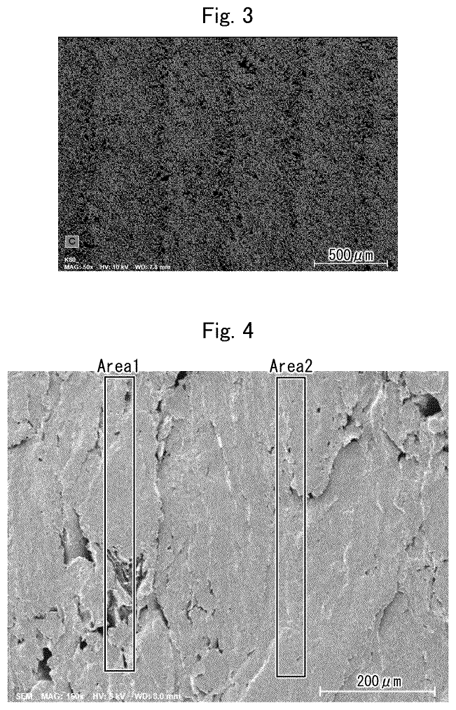

An ultra-high resolution scanning electron microscope (ULTRAplus: manufactured by Carl Zeiss) was used as an SEM. As an energy-dispersive X-ray analyzer (EDX), QUANTAX XFlash 5010 manufactured by Bruker AXS which was attached to the SEM was used. Then, a surface of the thermally conductive sheet was observed and mapping was carried out. From images obtained as a result, specifically, an SEM image and an image showing a result of identification of carbon, distribution of atomic number densities for carbon atoms was observed and whether a portion where the carbon content was different existed was checked. Conditions for observation using the SEM and conditions for analysis using the EDX were as follows. Note that FIG. 2 shows an SEM image of the surface of the thermally conductive sheet obtained in Example 1. The SEM image was obtained as a result of observing the surface with use of the SEM to which the EDX was attached, i.e., by an SEM-EDX. FIG. 3 shows an image which shows a result of identification of carbon.

### <Conditions for Observation Using SEM>

Acceleration voltage: 5 kV, and
Detector: SE2 (chamber-type secondary electron detector)

### <Conditions for Analysis Using EDX>

Accelerated voltage: 10 kV (elemental mapping at a low magnification), and 5 kV (elemental mapping and area analysis at a high magnification), and
Analysis method: ZAF method.

### <Atomic Number Density of Carbon and Atomic Number Density of Oxygen>

A surface of the thermally conductive sheet in accordance with an embodiment of the present invention and a surface of a comparative thermally conductive sheet were subjected to elemental mapping. Thus, an in-plane distribution of element was checked. Next, area analysis and semi-quantitative analysis by the ZAF method were carried out on the thermally conductive sheet in accordance with an embodiment of the present invention. In an image observed by an SEM, as shown in FIG. 4, the following regions were set as objects of the area analysis: (i) a 500 μm×50 μm area (area 1) including a region that appeared darker than surrounding regions and (ii) a 500 μm×50 μm area (area 2) including no region that appeared darker than surrounding regions.

The atomic number density of carbon and the atomic number density of oxygen of the areas 1 and 2 were obtained by the ZAF method. Thereafter, the “atomic number density of carbon atoms in area 2 (a2) (atom %)−the atomic number density of carbon atoms in area 1 (a1) (atom %)” was calculated.

### <Half Width of Peak Representing (002) Plane of Graphite Particles (A)>

With use of a two-dimensional X-ray diffraction (XRD) device (Nano-Viewer small angle scattering measurement instrument, manufactured by Rigaku Corporation) on a surface of the thermally conductive sheet, an XRD profile was obtained by measuring the X-ray diffraction intensity under conditions described in <XRD measurement conditions> below. A peak located in a range of 20=24° to 29° in the XRD profile obtained was regarded as a peak representing the (002) plane of the graphite particles (A), and a half width of the peak was measured.

### <XRD Measurement Conditions>

Tube: Cukα line, Output: 40 kV-30 mA,
Slit: 1st slit: 0.4 mm, 2nd slit: 0.2 mm, and 3rd slit: 0.45 mm,
Measurement method: transmission method,
Detector: HyPix-3000,
Exposure time: 15 minutes,
Camera length: 62 mm, and
Probe diameter: approximately φ 1 mm.

### <Thermal Resistance Value>

A 1 mm square piece was cut out from a thermally conductive sheet and used as an evaluation sample. For the evaluation sample, a thermal resistance value (cm²K/W) of the thermally conductive sheet was obtained by measurement with use of a thermal resistance measurement device (resin material thermal resistance measurement device manufactured by Hitachi Technologies and Services, Ltd.) at a sample temperature of 50° C. and a pressure of 0.5 MPa.

The thermal resistance value of the thermally conductive sheet was evaluated by the following criteria:
A (excellent): a case where the thermal resistance value of the thermally conductive sheet is not more than 0.080 cm²K/W
B (good): a case where the thermal resistance value of the thermally conductive sheet is more than 0.080 cm²K/W and not more than 0.10 cm²K/W
C (poor): a case where the thermal resistance value of the thermally conductive sheet is more than 0.10 cm²K/W

### <Temporary Attachment Property>

The temporary attachment property of the thermally conductive sheet is evaluated by: peeling a 40 mm×40 mm sized piece of the thermally conductive sheet off from a separator (backing sheet); and bonding this piece of the thermally conductive sheet to a 50 mm×50 mm piece of a silicon wafer. The excellent temporary attachment property means the following:
The thermally conductive sheet is easily peeled off from the separator.
The thermally conductive sheet can be fixed and bonded accurately on the silicon wafer.
Even in a case where the silicon wafer is transported or turned upside down, the thermally conductive sheet does not peel off.
The air entrained between the silicon wafer and the thermally conductive sheet is easily released.

The criteria for evaluation are as follows.
A: (excellent) The thermally conductive sheet is easily peeled off from the separator and easily bonded to a silicon wafer, and air is unlikely to be entrained.
B: (good) The thermally conductive sheet is easily peeled off from the separator and easily bonded to a silicon wafer (a little lightly bonded), and air is unlikely to be entrained.
C: (poor) The thermally conductive sheet is difficult to peel off from the separator and too firmly bonded to a silicon wafer, and air is entrained. Alternatively, the thermally conductive sheet peels off too much from the separator and is not bonded to the silicon wafer.

### <Initial Adhesion>

Silicon (50 mm×50 mm×0.7 mm), a thermally conductive sheet (40 mm×40 mm×0.11 mm), and a spreader (nickel-plated copper: 50 mm×50 mm×2 mm) were stacked in this order on a heat press device and set. Subsequently, the heat press device was used to bond the silicon, the thermally conductive sheet, and the spreader in this order under conditions of 150° C. and 100 kg. This resulted in obtainment of an adhesion measurement laminate. Subsequently, a scanning acoustic tomograph (product name: FineSAT, manufactured by Hitachi Power Solutions Co., Ltd.) was used to measure an area of adhesion between the thermally conductive sheet and adherends (the silicon and the spreader) in the adhesion measurement laminate.

The initial adhesion of the thermally conductive sheet was evaluated by the following criteria:
A (excellent): a case where the area of adhesion is not less than 95% of the area of the entire surface on a side of the thermally conductive sheet which side adheres to the adherend
B (good): a case where the area of adhesion is not less than 90% and less than 95% of the area of the entire surface on the side of the thermally conductive sheet which side adheres to the adherend
C (poor): a case where the area of adhesion is less than 90% of the area of the entire surface on the side of the thermally conductive sheet which side adheres to the adherend
   <Adhesion after Maintaining Thermally Conductive Sheet at High Temperature>

An adhesion measurement laminate was obtained by the same method as described in the above <Initial adhesion> section. Subsequently, the adhesion measurement laminate was placed in a heating furnace and then maintained for 100 hours with ambient temperature inside the heating furnace heated to 150° C. Thereafter, the adhesion measurement laminate was removed from the heating furnace, and an area of adhesion between the thermally conductive sheet and the adherends (the silicon and the spreader) in the adhesion measurement laminate was measured. Adhesion after maintaining the thermally conductive sheet at high temperature was evaluated on the basis of the area of adhesion by the same criteria as the evaluation criteria for the initial adhesion that are described in the above <Initial adhesion> section.

<Adhesion after Heat Cycles>

Adhesion after heat cycles was evaluated by the same method as described in the above <Adhesion after maintaining thermally conductive sheet at high temperature> section, except for matters described below. Note that the adhesion after heat cycles was evaluated by criteria identical to the evaluation criteria for the initial adhesion described in the above <Initial adhesion> section.
An adhesion measurement laminate was placed in a heat shock tester (product name: ES-56L, manufactured by Hitachi Appliances, Ltd.) instead of the heating furnace. Subsequently, a heat cycle was repeated 500 times. In the heat cycle, ambient temperature inside the heat shock tester was raised to 120° C., then lowered to −40° C., and subsequently raised again to 120° C.

### Example 1

### <Preparation of Composition Solution>

A planetary centrifugal mixer was used to stir and mix materials (shown below) over 10 minutes to obtain a composition solution. The composition solution had a solid content concentration of 30.0% by weight. The composition solution corresponds to a “mixture containing the graphite particles (A), the organic polymer compound (B), and a solvent” in the present production method.
As the graphite particles (A), scale-like graphite powder (average particle size: 73 μm, thickness: 0.80 μm, aspect ratio: 91, and sulfur content: not more than 1.0% by weight): 115.42 g (50.5 parts by weight);
As the acrylic resin having a functional group, a 15% by weight toluene/ethyl acetate solution containing an acrylic resin (weight average molecular weight: 900,000, Tg: −60° C., content of a hydroxyl group as the functional group: 0.116 mmol/g, 6.5 KOH mg/g, liquid at normal temperature): 388.54 g (58.28 g (25.5 parts by weight) as the acrylic resin having a functional group);
As the acryl block copolymer, a 15% by weight toluene/ethyl acetate solution containing an acryl block copolymer (weight average molecular weight: 56,000, Tg: hard segment 100° C. to 120° C. and soft segment −50° C. to −40° C., without the functional group, liquid at normal temperature): 129.49 g (19.42 g (8.5 parts by weight) as the acryl block copolymer without a functional group);
A tackifier (hydrogenated petroleum resin having a softening point of 90° C.): 22.86 g;
A plasticizer (polybutene having a weight average molecular weight of 3700): 11.43 g;
An anti-aging agent (amine-based anti-aging agent: 4,4′-bis(α,α-dimethylbenzyl)diphenylamine): 1.14 g; and
Toluene: used in an amount which causes the solid content concentration of the composition solution to be 30.0% by weight.

### <Preparation of Primary Sheet>

A resultant composition solution was applied to and spread on a polyethylene terephthalate film with a release-treated surface in a mold having a thickness of 2 mm, and a portion that was thicker than 2 mm was scraped off. Thereafter, a resulting sheet was dried at 120° C. for not less than 20 minutes, and a dried sheet was peeled off, so that a primary sheet having a thickness of 2 mm was obtained. This operation was repeated three times to produce three primary sheets. The primary sheets fall under the primary sheet prior to pressure application.

The content of the graphite particles, the acrylic ester-based resin, and the anti-aging agent relative to the total weight of the composition contained in the primary sheet corresponds to the content relative to the total weight of the composition contained in a thermally conductive sheet that is finally obtained, i.e., the thermally conductive sheet that is finally obtained.

### <Preparation of Laminate>

From each of the three primary sheets obtained, a 2.4 cm×6.4 cm piece was cut out. Every time one sheet (piece) was stacked in a container having an internal volume of 2.5 cm×6.5 cm×7.5 cm in height, the stacked sheet(s) was pressed at normal temperature and a pressure of 2.5 MPa. Then, stacking and pressing were repeated. Next, the above-described stack was heated at 120° C. for 15 minutes and then pressed at a pressure of 2.5 MPa (25.5 kg/cm²), so that a 2.5 cm×6.5 cm×6.5 cm laminate was obtained. In the above pressing, pressure was applied so that the thickness of the primary sheet after pressure application which constituted the laminate became 0.5 mm, that is, in a case where the thickness of the primary sheet prior to pressure application was set to 100%, the thickness of the primary sheet after pressure application became 25%.

### <Preparation of Thermally Conductive Sheet>

By slicing a multilayer cross section of the obtained laminate at an angle of 45 degrees relative to the layer-stacking direction, a thermally conductive sheet was produced which had a size of 6.5 cm in length×6.5 cm in width×110 μm in thickness.

### Example 2

Operations were carried out in the same manner as those in Example 1, except that when the laminate was produced, pressing was carried out every time 5 primary sheets were stacked instead of pressing carried out every time a single primary sheet was stacked. A thermally conductive sheet having a size of 6.5 cm in length×6.5 cm in width×110 μm in thickness was thus produced. Note that also in Example 2, pressing in laminate production was carried out so that the thickness of the primary sheet after pressure application became 0.5 mm, i.e., 25% in a case where the thickness of the primary sheet prior to pressure application was set to 100%.

### Example 3

Operations were carried out in the same manner as those in Example 1, except that when the laminate was produced, pressing was carried out every time 10 primary sheets were stacked instead of pressing carried out every time a single primary sheet was stacked. A thermally conductive sheet having a size of 6.5 cm in length×6.5 cm in width×110 μm in thickness was thus produced. Note that also in Example 3, pressing in laminate production was carried out so that the thickness of the primary sheet after pressure application became 0.5 mm, i.e., 25% in a case where the thickness of the primary sheet prior to pressure application was set to 100%.

### Example 4

Operations were carried out in the same manner as those in Example 1, except that, in preparation of the primary sheet, a mold that would cause a resultant coating film to have a thickness of 3 mm was provided instead of a mold that would cause a resultant coating film to have a thickness of 2 mm. As a result, a thermally conductive sheet having a size of 6.5 cm in length×6.5 cm in width×110 μm in thickness was produced. Note that in Example 3, the primary sheet prior to pressure application had a thickness of 3 mm. Further, pressing in laminate production was carried out so that the thickness of the primary sheet after pressure application became 0.75 mm, i.e., 25% in a case where the thickness of the primary sheet prior to pressure application was set to 100%.

### Example 5

Operations were carried out in the same manner as those in Example 1, except that: (i) an amount of toluene used at the time of preparation of a composition solution was changed to an amount in which the solid content concentration of the composition solution was 20.0% by weight, (ii) when a laminate was prepared, pressing was carried out every time 5 primary sheets were stacked instead of pressing carried out every time a single primary sheet was stacked, and (iii) a method of the pressing was changed so that the thickness of the primary sheet after pressure application became 0.33 mm, that is, 17% in a case where the thickness of the primary sheet prior to pressure application was set to 1008. As a result, a thermally conductive sheet having a size of 6.5 cm in length×6.5 cm in width×110 μm in thickness was produced.

### Comparative Example 1

### <Preparation of Composition>

While heating, the following were melt-kneaded: as the graphite particles (A), 120 g of a scale-like expanded graphite powder (average particle size: 250 μm, thickness: 5 μm, aspect ratio: 50, and sulfur content: not less than 1.5% by weight); as the organic polymer compound (B), 54 g of an acrylic ester-based resin (weight average molecular weight: 1,200,000, Tg: −37° C., containing an OH group as a functional group); and 66 g of an aromatic condensed phosphate ester (CR-741, manufactured by Daihachi Chemical Industry Co., Ltd.). A composition was thus obtained.

### <Preparation of Primary Sheet>

Part of 240 g of the composition obtained was taken, rolled into a lump, and sandwiched between PTFE films. Then, a press having a tool surface of 10 cm×20 cm was used to press under a condition of a tool temperature of 170° C. As a result, a primary sheet having a thickness of 2 mm was obtained. This operation was repeated to produce 12 primary sheets. The primary sheets fall under the primary sheet prior to pressure application.

### <Preparation of Laminate>

A 2.4 cm×6.4 cm piece was cut out from each of all the primary sheets thus obtained, and stacked in a container having an internal volume of 2.5 cm×6.5 cmx 7.5 cm in height. A stack prior to pressure application was thus obtained. The above-described stack prior to pressure application was heated at 120° C. for 15 minutes and then pressed at a pressure of 2.5 MPa (25.5 kg/cm²), so that a 2.5 cm×6.5 cm×6.5 cm laminate was obtained. In the above pressing, pressure was applied so that the thickness of primary the sheet after pressure application which constituted the laminate became 2.00 mm, that is, in a case where the thickness of the primary sheet prior to pressure application was set to 100%, the thickness of the primary sheet after pressure application became 100%.

### <Preparation of Comparative Thermally Conductive Sheet>

By slicing a multilayer cross section of the obtained laminate at an angle of 45 degrees relative to the layer-stacking direction, a comparative thermally conductive sheet was produced which had a size of 6.5 cm in length×6.5 cm in width×110 μm in thickness.

### (Evaluation of Thermally Conductive Sheets)

Table 1 shows results of measuring, on the basis of the above-described evaluation methods, physical properties of each of the thermally conductive sheets obtained in Examples 1 to 5 and the thermally conductive sheet obtained in Comparative Example 1. In Table 1, “Compression rate” means the above-described “ratio of the thickness of the primary sheet after pressure application in a case where the thickness of the primary sheet prior to pressure application was set to 100%”. In Table 1, the “Number of stacked sheets prior to pressing” described in Table 1 indicates how many primary sheets prior to pressure application were stacked for each pressing during formation of the laminate, and the “all sheets in laminate” in Comparative Example 1 means that a single press was carried out after all primary sheets prior to pressure application were stacked. In Table 1, “Half width” means a “Half width of a peak representing the (002) plane of the graphite particles (A)”. In Table 1, “(a2)-(a1)” means the above “atomic number density of carbon atoms in area 2 (a2) (atom %)−the atomic number density of carbon atoms in area 1 (a1) (atom %)”. The “average particle size of the graphite particles (A)” described in Table 1 means the above “average particle size of the graphite particles (A) eluted from the thermally conductive sheet”.

TABLE 1

| | | Example | Example | Example | Example | Example | Comparative |
|---|---|---|---|---|---|---|---|
| | | 1 | 2 | 3 | 4 | 5 | Example 1 |
| Composition | Presence/absence of | present | present | present | present | present | absent |
| | solvent | | | | | | |
| | Solid content | 30 | 30 | 30 | 30 | 20 | —** |
| | concentration | | | | | | |
| | [wt %] | | | | | | |
| Number of stacked sheets prior to | | 1 | 5 | 10 | 5 | 5 | All sheets |
| pressing | | sheet | sheets | sheets | sheets | sheets | in laminate |
| Primary | Thickness [mm] | 2 | 2 | 2 | 3 | 2 | 2 |
| sheet prior | Density [g/cm³] | 0.30 | 0.30 | 0.30 | 0.30 | 0.20 | 1.25 |
| to pressing | Tensile strength | 0.10 | 0.10 | 0.10 | 0.10 | 0.07 | 0.90 |
| | [MPa] | | | | | | |
| | In-plane orientation | ≤2.0 | ≤2.0 | ≤2.0 | ≤2.0 | ≤2.0 | >2.0 |
| | degree of (002) planes | | | | | | |
| | of graphite particles | | | | | | |
| Primary | Thickness [mm] | 0.5 | 0.5 | 0.5 | 0.75 | 0.33 | 2.00 |
| sheet after | Compression rate | 25 | 25 | 25 | 25 | 17 | 100 |
| pressing | [%] | | | | | | |
| Thermally | Thickness [mm] | 110 | 110 | 110 | 110 | 110 | 250 |
| conductive | Average particle | 69.5 | 69.5 | 69.5 | 69.5 | 69.5 | —* |
| sheet | diameter of graphite | | | | | | |
| | particles (A) | | | | | | |
| | [μm] | | | | | | |
| Thermally | Half width | —* | 52.5 | —* | —* | —* | 44.4 |
| conductive | Presence/absence of | absent | absent | absent | absent | absent | present |
| sheet | hole | | | | | | |
| | Presence/absence of | present | present | present | present | present | absent |
| | portion where carbon | | | | | | |
| | content is different | | | | | | |
| | (a2)-(a1) | 4.2 | 4.2 | 4.2 | 4.2 | 4.2 | 0.0 |
| | Thermal resistance | A | A | A | A | A | B |
| | Temporary attachment | A | A | A | A | A | B |
| | property | | | | | | |
| | Initial adhesion | A | A | A | A | A | C |
| | Adhesion after | A | A | A | A | A | C |
| | maintaining thermally | | | | | | |
| | conductive sheet at | | | | | | |
| | high temperature | | | | | | |
| | Adhesion after heat | A | A | A | A | A | C |
| | cycles | | | | | | |

*In the column of “Half width” in Examples 1 and 3 to 5 and the column of “Average particle diameter of the graphite particles (A)” in Comparative Example 1, “—” indicates that no measurement was made and the value is unknown.
**In the column of “Solid content concentration” in Comparative Example 1, “—” indicates that the composition in Comparative Example 1 was not in solution form.

In view of the descriptions in Examples 1 to 5 and in Table 1, it can be understood that the method for producing a thermally conductive sheet in each of Examples 1 to 5 included the following steps.
A primary sheet forming step of obtaining a primary sheet by forming, in sheet form, a mixture containing graphite particles (A), an organic polymer compound (B), and a solvent.
A laminate forming step of obtaining a primary sheet laminate, by stacking a plurality of the primary sheets while applying pressure so that the thickness of the primary sheets is reduced.
A slicing step of obtaining a thermally conductive sheet by slicing a multilayer cross section of the primary sheet laminate.

Thus, the method for producing a thermally conductive sheet in each of Examples 1 to 5 falls under the present production method.

In contrast, in Comparative Example 1, no solvent is used. Thus, the method in Comparative Example 1 does not fall under the present production method.

As shown in Table 1, the thermally conductive sheets described in Examples 1 to 5 have lower thermal resistance, better thermal conductivity, a higher temporary attachment property, higher initial adhesion, higher adhesion after maintained at high temperature, higher adhesion after heat cycles, and better adhesion than the comparative thermally conductive sheet described in Comparative Examples 1.

Therefore, it is clear that the present production method makes it possible to produce a thermally conductive sheet having excellent thermal conductivity, an excellent temporary attachment property, and excellent adhesion.

In addition, it is clear from illustrations of FIGS. 1 to 4 that in the primary sheet described in Example 1, there is no in-plane orientation.

### INDUSTRIAL APPLICABILITY

A method in accordance with an embodiment of the present invention for producing a thermally conductive sheet makes it possible to produce a thermally conductive sheet that has not only excellent thermal conductivity but also excellent adhesion. Therefore, the method in accordance with an embodiment of the present invention for producing a thermally conductive sheet can be suitably used to produce a product which uses a thermally conductive sheet and in which the thermally conductive sheet is required to have excellent thermal conductivity and excellent adhesion to an adherend. Examples of such a product include electronic components including, for example, a wiring board and semiconductor package.

1. A method for producing a thermally conductive sheet, comprising:
obtaining a primary sheet by forming, in sheet form, a mixture containing graphite particles, an organic polymer compound, and a solvent;
obtaining a primary sheet laminate, by stacking a plurality of the primary sheets while applying pressure so that thickness of the primary sheets is reduced; and
obtaining a thermally conductive sheet by slicing a multilayer cross section of the primary sheet laminate.

2. The method according to claim 1, wherein
in the obtaining a primary sheet laminate, the pressure is applied so that, in a case where the thickness of the primary sheet prior to application of the pressure is set to 100%, the thickness becomes not more than 95%.

3. The method according to claim 1, wherein
the primary sheet obtained in the obtaining a primary sheet has a density of not more than 1.2 g/cm³.

4. The method according to claim 1, wherein
the thickness of the primary sheet obtained in the obtaining a primary sheet is more than 20 times an average particle size of the graphite particles.

5. The method according to claim 1, wherein
the primary sheet is planar and, in the obtaining a primary sheet laminate, the laminate is obtained by stacking the primary sheet that is planar in a normal direction to a planar surface of the primary sheet.

6. The method according to claim 1, wherein
the mixture has a solid content concentration of from 10% by weight to 40% by weight relative to a total weight of the mixture.

7. The method according to claim 1, wherein
in the obtaining a primary sheet laminate, when the pressure is applied to the primary sheet, the pressure is not less than 1 kg/cm².

8. The method according to claim 1, wherein
the mixture includes the graphite particles in an amount of more than 50% by weight relative to a total weight of solid content of the mixture.

9. The method according to claim 1, wherein
the graphite particles have a short-axis average value or minimum-length average value of not more than 5 μm.

10. The method according to claim 1, wherein
the graphite particles have an average particle size that is not less than 50% relative to the thickness of the thermally conductive sheet.

11. The method according to claim 1, wherein
the graphite particles have an aspect ratio of not less than 10.

12. The method according to claim 1, wherein
the primary sheet obtained in the obtaining a primary sheet has a tensile strength of not more than 0.5 MPa.

13. The method according to claim 1, wherein
in a β profile which is obtained by
extracting a (002) peak of the graphite particles from an X-ray diffraction (XRD) profile which is obtained by measuring an X-ray diffraction intensity with use of a two-dimensional XRD device on a surface of the primary sheet obtained in the forming of a primary sheet, and
plotting an intensity distribution in a circumferential direction,
a ratio of a maximum value and a minimum value of the (002) peak of the graphite particles in a β profile is not more than 4.0.

14. The method according to claim 1, wherein
in the obtaining a thermally conductive sheet, the multilayer cross section of the laminate is sliced so that the thickness of the thermally conductive sheet obtained becomes not more than 150 μm.

15. The method according to claim 1, wherein
in an X-ray diffraction (XRD) profile which is obtained by measuring an X-ray diffraction intensity with use of a two-dimensional XRD device on a surface of the thermally conductive sheet, a peak representing a (002) plane of the graphite particles (A) has a half width of 45° to 63°.
